(19) United States
(12) Patent Application Publication
(10) Pub. No.: US 2016/0063106 A1
(43) Pub. Date: Mar. 3, 2016

(54) Related Entity Search

(71) Applicants: Ying Chai, Shanghai (CN); David Francois Huynh, San Francisco, CA (US); JinYu Lou, Shanghai (CN); Chen Ding, Redwood City, CA (US)

(72) Inventors: Ying Chai, Shanghai (CN); David Francois Huynh, San Francisco, CA (US); JinYu Lou, Shanghai (CN); Chen Ding, Redwood City, CA (US)

(73) Assignee: Google Inc., Mountain View, CA (US)

(21) Appl. No.: 13/569,698

(22) Filed: Aug. 8, 2012

(51) Int. Cl. G06F 17/30

(52) U.S. Cl. CPC G06F 17/30864; G06F 17/30958

(57) ABSTRACT

Methods, systems, and computer-readable media are provided for related entity search. In some implementations, a search system identifies a collection of entities associated with a search query. The search system identifies entities related to those entities, and determines the relationships between them. The search system provides access to one or more collections of related results identifying entities based on the determined relationships.

### BACKGROUND

The present disclosure relates to providing related search queries. Conventional search engines receive search queries from users and provide search results. Some conventional search engines provide related search queries based on the search query.

### SUMMARY

Methods, systems, and computer-readable media are provided for related entity search.

In some implementations, a method for search is provided. In the method, a plurality of search results are obtained from a knowledge graph, wherein each respective search result of the plurality of search results is associated with an entity in the knowledge graph. One or more related entities in the knowledge graph are identified, wherein each related entity is related to at least one of the entities associated with the plurality of search results. One or more relationships are determined between each of the one or more entities and the one or more related entities. Access to a related plurality of search results is provided, wherein the related plurality of search results is determined based at least in part on one of the one or more relationships.

In some implementations, a system comprising one or more computers is configured to perform operations. The system obtains a plurality of search results from a knowledge graph, wherein each respective search result of the plurality of search results is associated with an entity in the knowledge graph. The system identifies one or more related entities in the knowledge graph, wherein each related entity is related to at least one of the entities associated with the plurality of search results. The system determines one or more relationships between each of the one or more entities and the one or more related entities. The system provides access to a related plurality of search results, wherein the related plurality of search results is determined based at least in part on one of the one or more relationships.

In some implementations, a non-transitory computer-readable medium for search, the computer-readable medium having instructions recorded thereon is provided. The instructions comprise obtaining, using one or more processors, a plurality of search results from a knowledge graph, wherein each respective search result of the plurality of search results is associated with an entity in the knowledge graph. The instructions comprise identifying, using one or more processors, one or more related entities in the knowledge graph, wherein each related entity is related to at least one of the entities associated with the plurality of search results. The instructions comprise determining, using one or more processors, one or more relationships between each of the one or more entities and the one or more related entities. The instructions comprise providing, using one or more processors, access to a related plurality of search results, wherein the related plurality of search results is determined based at least in part on one of the one or more relationships.

### BRIEF DESCRIPTION OF THE FIGURES

FIG. 1 shows an information flow diagram in accordance with some implementations of the present disclosure;

FIG. 2 shows an illustrative user interface with links to related collections in accordance with some implementations of the present disclosure;

FIG. 3 shows an illustrative user interface with a pull down menu to related collections in accordance with some implementations of the present disclosure;

FIG. 4 shows an illustrative user interface with links to related entities in accordance with some implementations of the present disclosure;

FIG. 5 shows an illustrative knowledge graph portion containing nodes and edges in accordance with some implementations of the present disclosure;

FIG. 6 shows an illustrative knowledge graph portion in accordance with some implementations of the present disclosure;

FIG. 7 shows an illustrative knowledge graph portion in accordance with some implementations of the present disclosure;

FIG. 8 shows a flow diagram including illustrative steps for related entity reference search in accordance with some implementations of the present disclosure;

FIG. 9 shows an illustrative computer system that may be used to implement some or all features of the search system in accordance with some implementations of the present disclosure; and

FIG. 10 is a block diagram of a user device in accordance with some implementations of the present disclosure.

### DETAILED DESCRIPTION OF THE FIGURES

In some implementations, a search system retrieves search results based on a received search query. In an example, an internet search engine provides a list of documents in response to a query received from a user by comparing the query to an index. In some implementations, search results include a list of documents, a list of document identifiers, a collection of links, a collection of images, text, or other content, any other suitable results, or any combination thereof. In some implementations, it may be desirable to provide users with access to related collections of search results. In some implementations, the user may not know about, or may not know how to search for, related collections. For example, a user searching for movies including a certain actor may not know to search for a particular genre of movies including that actor. In some implementations, the search system identifies search results, related search collections, or both, based on a received search query and data stored in a data structure.

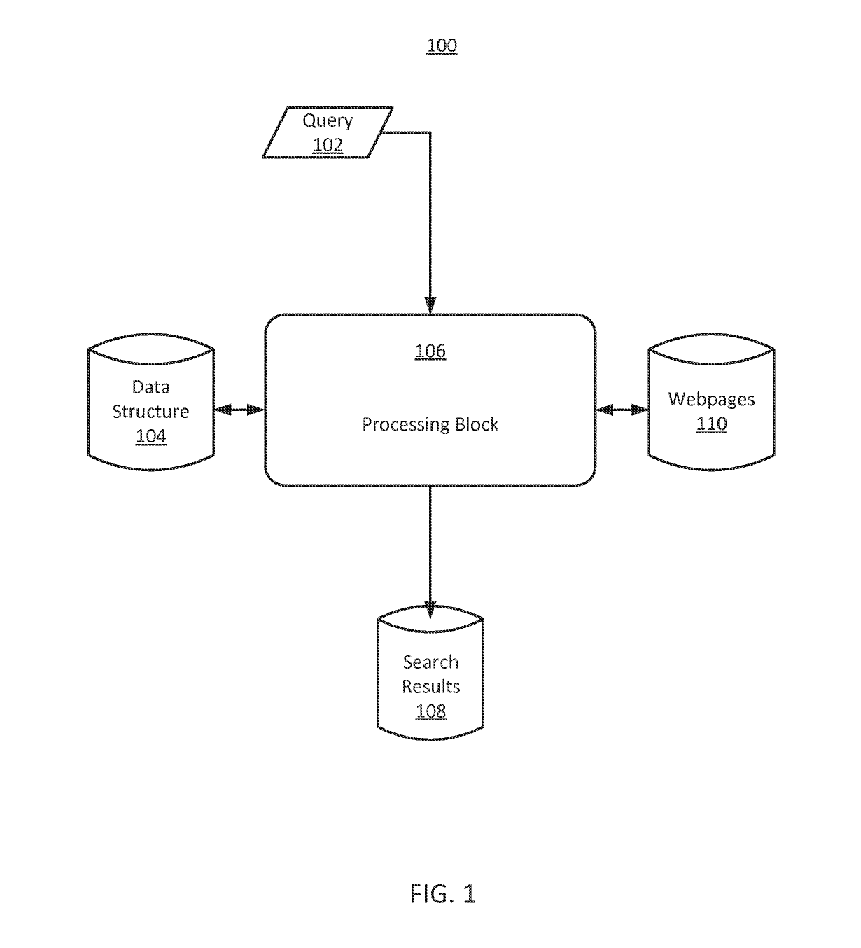

The following description and accompanying FIGS. 1-10 provide additional details and features of some implementations of the search system and its underlying system.

FIG. 1 shows information flow diagram 100 in accordance with some implementations of the present disclosure. Information flow diagram 100 includes processing block 106, query block 102, data structure block 104, webpages block 110, and search results block 108. In some implementations, the search system uses information from data structure block 104, webpages block 106, other sources not shown, or any combination thereof, to generate an output to search results block 108, based on a query received in query block 102.

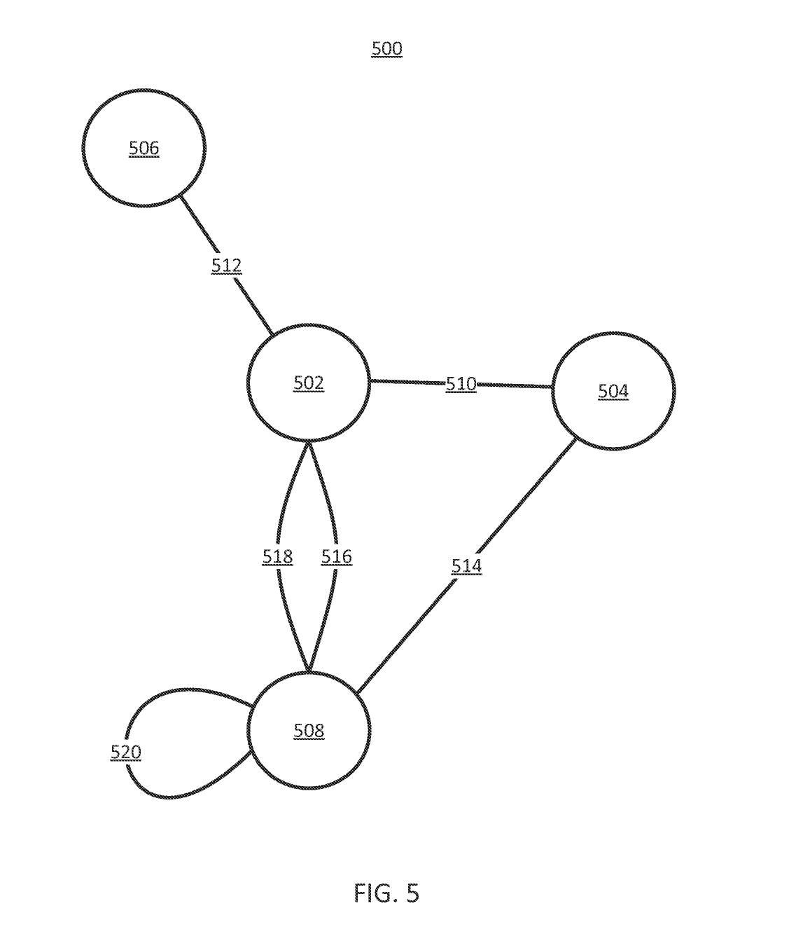

Data structure block 104 includes a data structure containing structured, e.g., organized, information. In some implementations, data structure block 104 contains a data graph, a database, an index, any other suitable collection of content, or any combination thereof. In an example, data structure block 104 includes a graph-based structure where information stored as nodes connected by edges, where the connections in part define the information. An implementation of a graph-based data structure referred to herein as a knowledge graph is described below in reference to FIGS. 5-7. In some implementations, a search query from query bock 102 may be used to query data structure block 104. In some implementations, search results are retrieved from data structure block 104. In some implementations, metrics are determined based on data stored in data structure block 104.

Webpages block 110 includes web sites and other suitable content. In an example, webpages block 110 includes webpages on the internet containing text, images, videos, links, other suitable content, or any combination thereof. In some implementations, webpages block 110 includes information from a database, private intranet, public network, private network, any other suitable collection of information, or any combination thereof.

Query block 102 includes a search query provided to processing block 106. In some implementations, the search query is a query received from a user. In some implementations, search queries are directed towards internet searches, text searches, image searches, database searches, searches of any other suitable index or collection of content, or any combination thereof. In some implementations, the search query is text-based, image-based, audio-based, of any other suitable format, or any combination thereof. In an example, the search query is a text-based search for webpages. In another example, the search query is an image-based search for images.

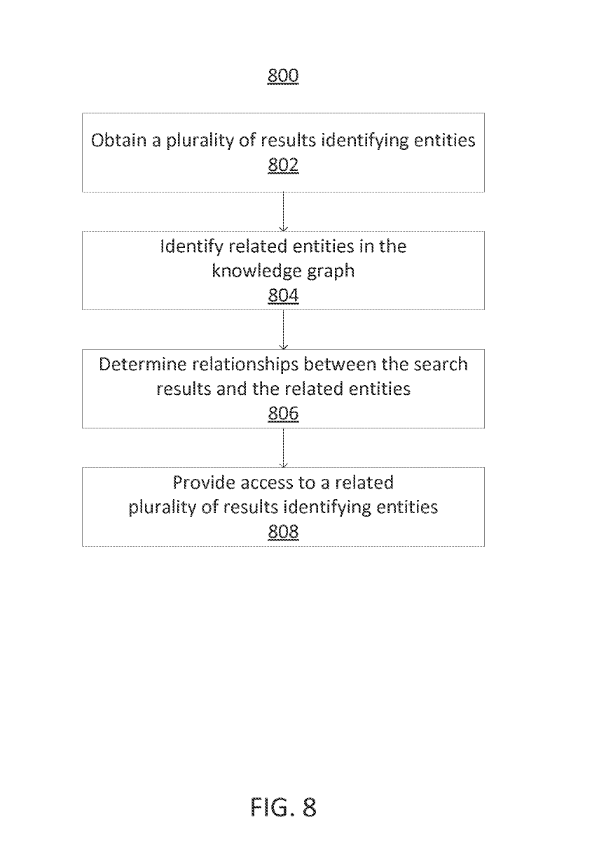

Processing block 106 includes processing steps for providing related search results. Details of the processing steps are discussed below in reference to flow diagram 800 of FIG. 8. In some implementations, processing block 106 identifies search results based on query block 102 from data structure block 104, from webpages block 110, from any other suitable source, or any combination thereof. In some implementations, processing block 106 identifies other topics and/or elements of the data structure stored in data structure block 104 related to the search results. Based on the related topics, the processing block 106 determines collections of related search results. In some implementations, these related search results and/or related collections are output to search results block 108.

Search results block 108 includes the output of processing block 106. In some implementations, search results block 108 includes text search results, image search results, audio search results, video search results, links to webpages, data from webpages block 110, data retrieved from data structure block 104, any other suitable content, or any combination thereof. In some implementations, search results in search results block 108 is organized based on the processing of processing block 106. In some implementations, search results block 108 are displayed to a user using, for example, a display screen.

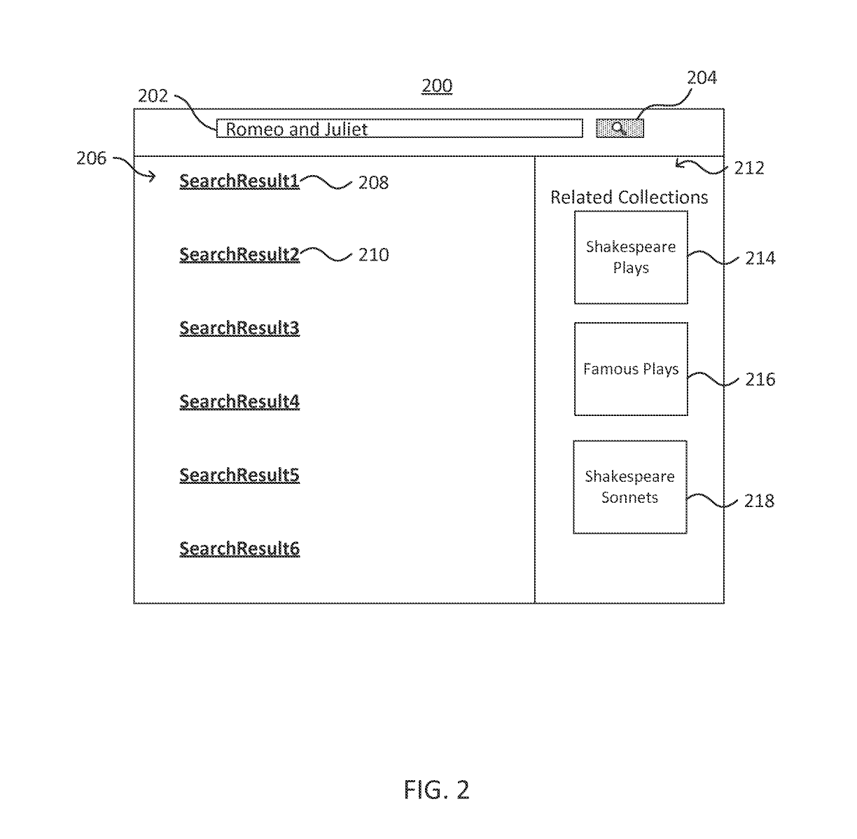

The following description and accompanying FIGS. 2-4 show illustrative user interfaces that may be used in some implementations of the present disclosure. In some implementations, the search results of search result block 108 of FIG. 1 are displayed using the user interfaces that follow. In some implementations, these user interfaces illustrate providing access to related search results, such as those generated by processing block 106 of FIG. 1. It will be understood that these interfaces are merely examples and that content may be displayed in any suitable technique. For example, search results and other content may be displayed horizontally, vertically, in a grid, in a scrollable window, in any other suitable technique, or any combination thereof. Search results may include text, images, video, links, any other suitable content, or any combination thereof. User interfaces may include any suitable elements not shown.

FIG. 2 shows illustrative user interface 200 with links to related collections in accordance with some implementations of the present disclosure. In some implementations, user interface 200 includes content that is displayed by the search system in response to receiving a search query. User interface 200 includes search box 202 and search button 204. In some implementations, the search system receives a search query from a user in search box 202. In some implementations, information in search box 202 relates to data in query block 102 of FIG. 1. In some implementations, the search query includes text, audio, images, any other suitable input, or any combination thereof. In some implementations, the search system receives input indicating a selection of search button 204, indicative of a desire to perform a search. In some implementations, input includes a mouse click, a touchscreen tap, a keystroke, any other suitable input, or any combination thereof. In some implementations, search results area 206 includes search results.

In some implementations, the search system displays one or more search results in response to receiving a search query in search box 202. For example, where the search query is “Romeo and Juliet,” the search system may display links to webpages or other information related to “Romeo and Juliet” such as SearchResult1 208 and SearchResult2 210. In some implementations, search results are based on an index search of the internet, a database search, a search of a data structure such as data structure block 104 of FIG. 1, a keyword search, any other suitable search technique, or any combination thereof. In an example, search results include topics identified in data structure block 104 of FIG. 1. In another example, search results include links to webpages. In some implementations, search results include text, images, audio, video, links to additional content such as webpages, contextual information such as page view statistics, social media information, any other suitable content, or any combination thereof. In some implementations, search results are arranged in a list, grid, matrix, map, timeline, chart, graph, horizontally scrollable layout, vertically scrollable layout, any other suitable arrangement, or any combination thereof. In some implementations, search results area includes other elements not shown, such as pagination links, a scroll bar, sorting options, any other suitable content, or any combination thereof.

In some implementations, related collection area 212 includes links to related entity references and/or links to collections of related results identify entities.

As used herein, an entity is a thing or concept that is singular, unique, well-defined and distinguishable. For example, an entity may be a person, place, item, idea, topic, abstract concept, concrete element, other suitable thing, or any combination thereof. In some implementations, search results and other content includes results identifying entities. As used herein, an entity reference is an identifier or other information that refers to an entity. For example, an entity may be the physical embodiment of George Washington, while an entity reference is an abstract concept that refers to George Washington. It will be understood that the terms entity and entity reference may be used interchangeably herein.

In some implementations, related collection area 212 provides access to similar and/or related topics as the topics included in the received search query. In some implementations, the search system determines the collections of related entity references in related collection area 212 based on the search query received in search box 202, the search results in search result area 206, data retrieved from a data structure such as data structure block 104 of FIG. 1, user input, user preferences, system parameters, user history, global search history, data stored in a knowledge graph, predetermined parameters, any other suitable data, or any combination thereof. In some implementations, processing block 106 of FIG. 1 determines related entity references based on retrieved data. For example, where the system receives the search query “Romeo and Juliet,” the search system may display links to related collections “Shakespeare Plays” 214, “Famous Plays” 216, and “Shakespeare Sonnets” 218.

In some implementations, the search system may identify that “Romeo and Juliet” refers to a play by the playwright William Shakespeare. The search system may, for example, identify data in a data structure such as a knowledge graph indicating this relationship. The search system may identify the related collections by determining, e.g. mapping, the relationships between a set of search results related to the search query and related entity references stored in the data structure. For example, the search system may identify the “author” relationship between the play “Romeo and Juliet” and “William Shakespeare,” and may identify other plays with the same relationship, resulting in related collection “Shakespeare Plays” 214. In another example, the search system may identify a fame and/or quality ranking associated with the play “Romeo and Juliet,” and may identify other plays with similar rankings or properties, resulting in related collection “Famous Plays” 216. In another example, the search system may identify that “Romeo and Juliet” is a play associated with William Shakespeare, and may identify a cluster of relationships between Shakespeare and sonnets, in addition to plays, resulting in providing a link to related collection “Shakespeare Sonnets” 118.

It will be understood that the particular aforementioned collections are merely an example and that the search system may determine any suitable related collections based on any suitable search query. It will also be understood that the particular size, location, and arrangement of search result area 206, related collection area 212, and other elements of user interface 200 are merely an example and that elements may be reconfigured in any suitable arrangement.

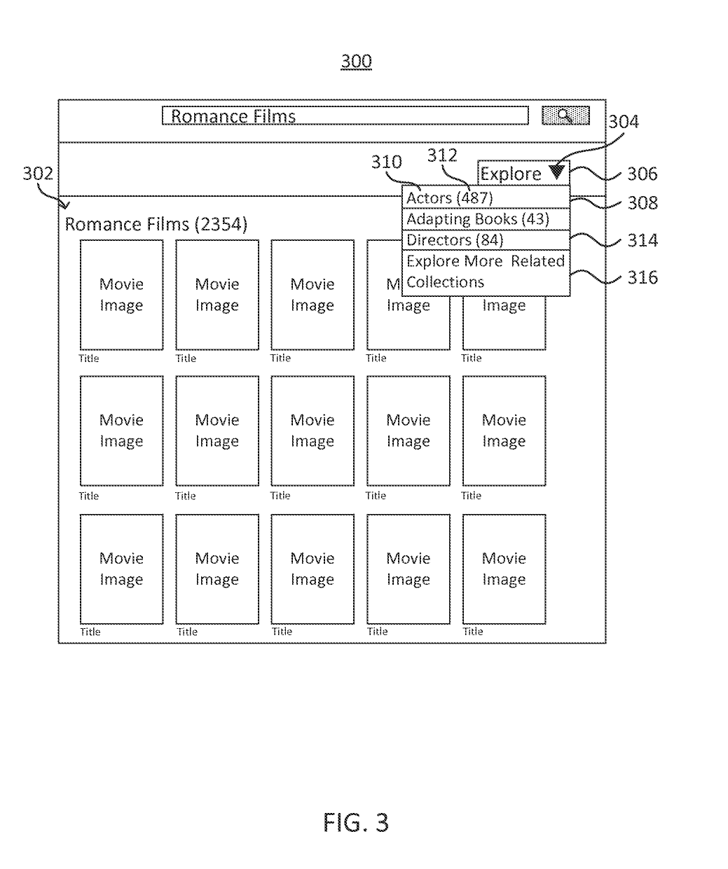

FIG. 3 shows illustrative user interface 300 with a pull down menu to related collections in accordance with some implementations of the present disclosure. In some implementations, user interface 300 includes content that is displayed by the search system in response to receiving a search query. User interface 300 includes access to related collections through pull down menu 306. In some implementations, the related collections of pull down menu 306 may be similar to those displayed in related collection area 212 of FIG. 2.

Search results area 302 includes a collection of search results displayed in response to a received search query. In some implementations, collections may be based on data retrieved by processing block 106 of FIG. 1 from data structure block 104 of FIG. 1, webpages block 110 of FIG. 1, any other suitable source, or any combination thereof. For example, where the received search query is “Romance Films,” the search system may determine that the user desires movies of the genre “Romance.” In some implementations, results may be determined based on relationships between data stored in a data structure such as a knowledge graph. For example, topics may be associated with both the category “Movie” and the genre “Romance.” In some implementations, search results may be determined based on a keyword, index, or other search of the internet, a database, any other suitable collection of information, or any combination thereof. Search results in search result area 302 may include links to other webpages or content, images, audio, video, text, data, descriptions, contextual information, or any combination thereof. In some implementations, receiving a selection of a search result in search result area 302 may cause the search system to reconfigure and/or rearrange user interface 300.

In some implementations, pull down menu 306 includes text such as “Explore,” indicating that it provides access to explore other collections. It will be understood that this text is merely an example and that any suitable text, image, other indication, or any combination thereof, may be displayed. In some implementations, pull down menu 306 includes pull down arrow 304. Receiving a selection of pull down arrow 304 may cause the search system to reconfigure user interface 300 such that pull down menu 306 becomes visible. It will be understood that any suitable icon and/or indicator may be used for pull down arrow 304. It will also be understood that in some implementations, pull down arrow 304 is omitted.

In the illustrated example, pull down menu 306 includes “Actors” link 308, “Directors” link 314 and “Explore more related collections” link 316. In some implementations, “Actors” link 308 includes identification text 310 and related collection count 312. For example, identification text 310 for “Actors” link 308 includes the text “Actors,” indicating the content of the related collection. In some implementations, where the received search query is “Romance Films,” the search system may display a collection of actors featured in romance films in response to receiving a selection of “Actor” link 308. In some implementations, identification text 310 may include a relatively longer description, such as “Actors Featured In Romance Films.” In some implementations, the search system determines the amount of text to display based on the user device, the screen size, user preferences, predetermined parameters, system settings, user history, any other suitable parameters, or any combination thereof. In some implementations, related collection count 312 indicates the number of entity references in the related collection. In some implementations, related collection count 312 is omitted. In some implementations, “Explore More Related Collections” link 316 provides access to a collection of links to related collections. For example, the search system may reconfigure the screen to display a list and/or grid of links to related collections in response to receiving a selection of link 316.

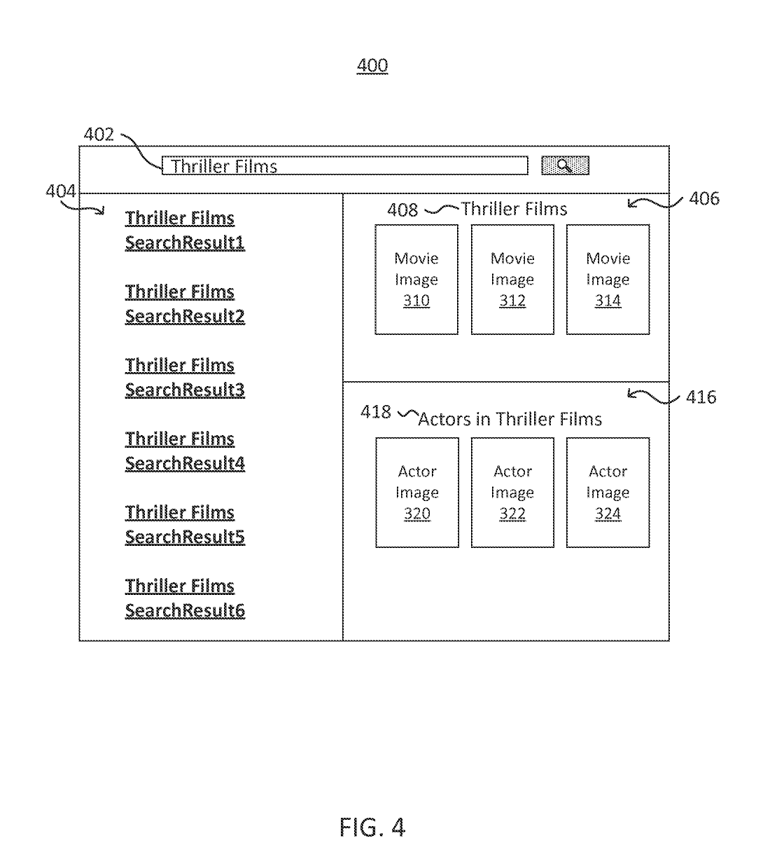

FIG. 4 shows illustrative user interface 400 with links to related entity references in accordance with some implementations of the present disclosure. In some implementations, user interface 400 initially provides links to entity references that may be part of a related collection, whereas user interface 300 of FIG. 3 initially provides links to the related collections.

User interface 400 includes search results area 404, related entity reference area 406, and related collection area 418. In some implementations, user interface 400 includes content displayed by a search system in response to receiving a search query. In some implementations, displayed content depends on a data structure such as data structure block 104 of FIG. 1, a search of the internet such as webpages block 110 of FIG. 1, any other suitable data source, or any combination thereof. In an example, content of related entity reference area 406 depends on data structure, while content in search results area 404 is based on an internet search of webpages.

In some implementations, the system receives the search query “Thriller Films” in search box 402. The search system displays search results in search result area 404. In some implementations, search box 402 is configured similarly to search box 202 of FIG. 2. In some implementations, search results area 404 is configured similarly to search results area 206 of FIG. 2. As described above, search results may be based on a search of the internet, a database, a data structure, any other suitable search, or any combination thereof, and may be displayed in any suitable list, grid, or other arrangement.

In some implementations, user interface 400 displays related collections including links to individual related entity references. For example, related entity reference area 406 may include a thumbnail links to related entity references of the related entity collection described by title 408. As used herein, a related entity is a second entity with some relationship to the first entity. As illustrated, related entity reference area 406 includes links to thriller film 410, thriller film 412, and thriller film 414. In an example, thriller film 410 includes a link to the movie “Jaws,” thriller film 412 includes a link to the movie “Psycho,” and thriller film 414 includes a link to the movie “Silence of the Lambs.” In some implementations, the entity references displayed in related collection area are associated with an entity reference in a data structure such as a knowledge graph. In some implementations, related entity reference area 406 includes a link providing access to further entities in the collection indicated by title 408. In some implementations, links in related entity reference area 406 include links, text, descriptions, images, audio, video, contextual information, statistical information, any other suitable content, or any combination thereof. In some implementations, the particular entities displayed in related entity reference area 406 are selected from the collection of related entity references based on popularity, user history, user preferences, system settings, predetermined parameters, statistical information, any other suitable information, or any combination thereof. For example, movies may be selected based on a ranking score, the age of the movie, and the popularity of the movie. In another example, entity references may be selected based on a statistical similarly to the search query and/or to search result.

In some implementations, the search system may determine to display a related collection of “Thriller Films” in related entity reference area 406 based on the received search query. The search system may determine a relationship between search results and an entity reference in a data structure such as a knowledge graph, and may determine that other entity references in the collection “Thriller Films” share that relationship. In some implementations, the search system may determine a set of entity references related to the search results in a data structure such as the knowledge graph, and may determine related search queries and/or related entity references based on the relationships between the search results and the related entity references.

Related collection area 416 includes title 418, indicating that the area contains links to entity references of the collection “Actors in Thriller Films.” In some implementations, related collection area 416 is configured similarly to related entity reference area 406. In some implementations, the search system may identify actors that star in thriller films as entity references related to the search result associated results identifying entities. Based on that relationship, the search system may determine the related entity collection “Actors in Thriller Films.” It will be understood that in some implementations, the particular collections displayed are selected based on statistical relationships between the search results and the collection, user preferences, popularity, global search history, user search history, system settings, predetermined parameters, any other suitable parameters, or any combination thereof.

The following description and accompanying FIGS. 5-7 described an illustrative knowledge graph that may be used with some implementations of the present disclosure. It will be understood that the knowledge graph is merely an example of a data structure that may be used by the search system, and that any suitable data structure may be used.

In some implementations, data may be organized in a database using any one or more data structuring techniques. For example, data may be organized in a graph containing nodes connected by edges. In some implementations, the data may include statements about relationships between things and concepts, and those statements may be represented as nodes and edges of a graph. The nodes each contain a piece or pieces of data and the edges represent relationships between the data contained in the nodes that the edges connect. In some implementations, the graph includes one or more pairs of nodes connected by an edge. The edge, and thus the graph, may be directed, i.e. unidirectional, undirected, i.e. bidirectional, or both, i.e. one or more edges may be undirected and one or more edges may be directional in the same graph. Nodes may include any suitable data or data representation. Edges may describe any suitable relationships between the data. In some implementations, an edge is labeled or annotated, such that it includes both the connection between the nodes, and descriptive information about that connection. A particular node may be connected by distinct edges to one or more other nodes, or to itself, such that an extended graph is formed. For purposes of clarity, a graph based on the structure described immediately above is referred to herein as a knowledge graph. In some implementations, the knowledge graph may be a useful for representing information and in providing information in search.

FIG. 5 shows illustrative knowledge graph 500 containing nodes and edges in accordance with some implementations of the present disclosure. Illustrative knowledge graph 500 includes nodes 502, 504, 506, and 508. Knowledge graph 500 includes edge 510 connecting node 502 and node 504. Knowledge graph 500 includes edge 512 connecting node 502 and node 506. Knowledge graph 500 includes edge 514 connecting node 504 and node 508. Knowledge graph 500 includes edge 516 and edge 518 connecting node 502 and node 508. Knowledge graph 500 includes edge 520 connecting node 508 to itself. Each aforementioned group of an edge and one or two distinct nodes may be referred to as a triple or 3-tuple. As illustrated, node 502 is directly connected by edges to three other nodes, while nodes 504 and 508 are directly connected by edges to two other nodes. Node 506 is connected by an edge to only one other node, and in some implementations, node 506 is referred to as a terminal node. As illustrated, nodes 502 and 508 are connected by two edges, indicating that the relationship between the nodes is defined by more than one property. As illustrated, node 508 is connected by edge 520 to itself, indicating that a node may relate to itself. While illustrative knowledge graph 500 contains edges that are not labeled as directional, it will be understood that each edge may be unidirectional or bidirectional. It will be understood that this example of a graph is merely an example and that any suitable size or arrangement of nodes and edges may be employed.

Generally, nodes in a knowledge graph can be grouped into several categories. Nodes may represent entities, organizational data such as entity types and properties, literal values, and models of relationships between other nodes.

In some implementations, entity types, properties, and other suitable content is created, defined, redefined, altered, or otherwise generated by any suitable technique. For example, content may be generated by manual user input, by automatic responses to user interactions, by importation of data from external sources, by any other suitable technique, or any combination thereof. For example, if a commonly searched for term is not represented in the knowledge graph, one or more nodes representing that node may be added. In another example, a user may manually add information and organizational structures.

A node of a knowledge graph may represent an entity. An entity is a thing or concept that is singular, unique, well-defined and distinguishable. For example, an entity may be a person, place, item, idea, abstract concept, concrete element, other suitable thing, or any combination thereof. An entity generally refers to the concept of the entity. It will be understood that in some implementations, the knowledge contains an entity reference, and not the physical embodiment of the entity. For example, an entity may be the physical embodiment of George Washington, while an entity reference is an abstract concept that refers to George Washington. In another example, the entity “New York City” refers to the physical city, and the knowledge graph uses a concept of the physical city as represented by, for example, an element in a data structure, the name of the entity, any other suitable element, or any combination thereof. It will be understood that the terms entity and entity reference may be used interchangeably herein.

Nodes are unique, in that no two nodes refer to the same thing or concept. Generally, entities include things or concepts represented linguistically by nouns. For example, the color “Blue,” the city “San Francisco,” and the imaginary animal “Unicorn” may each be entities.

A node representing organizational data may be included in a knowledge graph. These may be referred to herein as entity type nodes. As used herein, an entity type node may refer to a node in a knowledge graph, while an entity type may refer to the concept represented by an entity type node. An entity type may be a defining characteristic of an entity. For example, entity type node Y may be connected to an entity node X by an “Is A” edge or link, discussed further below, such that the graph represents the information “The Entity X Is Type Y.” For example, the entity node “George Washington” may be connected to the entity type node “President.” An entity node may be connected to multiple entity type nodes, for example, “George Washington” may also be connected to entity type node “Person” and to entity type node “Military Commander.” In another example, the entity type node “City” may be connected to entity nodes “New York City” and “San Francisco.” In another example, the concept “Tall People,” although incompletely defined, i.e., it does not necessarily include a definition of “tall”, may exist as an entity type node. In some implementations, the presence of the entity type node “Tall People,” and other entity type nodes, may be based on user interaction.

In some implementations, an entity type node may include or be connected to data about: a list of properties associated with that entity type node, the domain to which that entity type node belongs, descriptions, values, any other suitable information, or any combination thereof. A domain refers to a collection of related entity types. For example, the domain “Film” may include, for example, the entity types “Actor,” “Director,” “Filming Location,” “Movie,” any other suitable entity type, or any combination thereof. In some implementations, entities are associated with types in more than one domain. For example, the entity node “Benjamin Franklin” may be connected with the entity type node “Politician” in the domain “Government” as well as the entity type node “Inventor” in the domain “Business”.

In some implementations, properties associated with entity nodes or entity type nodes may also be represented as nodes. For example, nodes representing the property “Population” or “Location” may be connected to the entity type node “City.” The combination and/or arrangement of an entity type and its properties is referred to as a schema. In some implementations, schemas are stored in tables or other suitable data structures associated with an entity type node. In some implementations, the knowledge graph may be self-defining or bootstrapping, such that it includes particular nodes and edges that define the concept of nodes, edges, and the graph itself. For example, the knowledge graph may contain an entity node “Knowledge Graph” that is connected to property nodes that describe a knowledge graph's properties such as “Has Nodes” and “Has Edges.”

Specific values, in some implementations referred to as literals, may be associated with a particular entity in a terminal node by an edge defining the relationship. Literals may refer to values and/or strings of information. For example, literals may include dates, names, and/or numbers. In an example, the entity node “San Francisco” may be connected to a terminal node containing the literal “815,000” by an edge annotated with the property “Has Population.” In some implementations, terminal nodes may contain a reference or link to long text strings and other information stored in one or more documents external to the knowledge graph. In some implementations, literals are stored as nodes in the knowledge graph. In some implementations, literals are stored in the knowledge graph but are not assigned a unique identification reference as described below, and are not capable of being associated with multiple entities. In some implementations, literal type nodes may define a type of literal, for example “Date/Time,” “Number,” or “GPS Coordinates.”

In some implementations, the grouping of an edge and two nodes is referred to as a triple. The triple represents the relationship between the nodes, or in some implementations, between the node and itself. In some implementations, higher order relationships are modeled, such as quaternary and n-ary relationships, where n is an integer greater than 2. In some implementations, information modeling the relationship is stored in a node, which may be referred to as a mediator node. In an example, the information “Person X Donates Artifact Y To Museum Z” is stored in a mediator node connected entity nodes to X, Y, and Z, where each edge identifies the role of each respective connected entity node.

In some implementations, the knowledge graph may include information for differentiation and disambiguation of terms and/or entities. As used herein, differentiation refers to the many-to-one situation where multiple names are associated with a single entity. As used herein, disambiguation refers to the one-to-many situation where the same name is associated with multiple entities. In some implementations, nodes may be assigned a unique identification reference. In some implementations, the unique identification reference may be an alphanumeric string, a name, a number, a binary code, any other suitable identifier, or any combination thereof. The unique identification reference may allow the search system to assign unique references to nodes with the same or similar textual identifiers. In some implementations, the unique identifiers and other techniques are used in differentiation, disambiguation, or both.

In some implementations of differentiation, a node may be associated with multiple terms or differentiation aliases in which the terms are associated with the same entity. For example, the terms “George Washington,” “Geo. Washington, “President Washington,” and “President George Washington” may all be associated with a single entity, i.e., node, in the knowledge graph. This may provide differentiation and simplification in the knowledge graph.

In some implementations of disambiguation, multiple nodes with the same or similar names are defined by their unique identification references, by associated nodes in the knowledge graph, by any other suitable information, or any combination thereof. For example, there may be an entity node related to the city “Philadelphia,” an entity node related to the movie “Philadelphia,” and an entity node related to the cream cheese brand “Philadelphia.” Each of these nodes may have a unique identification reference, stored for example as a number, for disambiguation within the knowledge graph. In some implementations, disambiguation in the knowledge graph is provided by the connections and relationships between multiple nodes. For example, the city “New York” may be disambiguated from the state “New York” because the city is connected to an entity type “City” and the state is connected to an entity type “State.” It will be understood that more complex relationships may also define and disambiguate nodes. For example, a node may be defined by associated types, by other entity nodes connected to it by particular properties, by its name, by any other suitable information, or any combination thereof. These connections may be useful in disambiguating, for example, the node “Georgia” that is connected to the node “United States” may be understood represent the U.S. State, while the node “Georgia” connected to the nodes “Asia” and “Eastern Europe” may be understood to represent the country in eastern Europe.

In some implementations, a node may include or connect to data defining one or more attributes. The attributes may define a particular characteristic of the node. The particular attributes of a node may depend on what the node represents. In some implementations, an entity node may include or connect to: a unique identification reference, a list of entity types associated with the node, a list of differentiation aliases for the node, data associated with the entity, a textual description of the entity, links to a textual description of the entity, other suitable information, or any combination thereof. As described above, nodes may contain a reference or link to long text strings and other information stored in one or more documents external to the knowledge graph. In some implementations, the storage technique may depend on the particular information. For example, a unique identification reference may be stored within the node, a short information string may be stored in a terminal node as a literal, and a long description of an entity may be stored in an external document linked to by a reference in the knowledge graph.

An edge in a knowledge graph may represent a semantic connection defining a relationship between two nodes. The edge may represent a prepositional statement such as “Is A,” “Has A,” “Is Of A Type,” “Has Property,” “Has Value,” any other suitable statement, or any combination thereof. For example, the entity node of a particular person may be connected by a “Date Of Birth” edge to a terminal node containing a literal of his or her specific date of birth. In some implementations, the properties defined by edge connections of an entity node may relate to nodes connected to the type of that entity node. For example, the entity type node “Movie” may be connected to entity nodes “Actor” and “Director,” and a particular movie may be connected by an edge property “Has Actor” to an entity node representing a particular actor.

In some implementations, nodes and edges define the relationship between an entity type node and its properties, thus defining a schema. For example, an edge may connect an entity type node to a node associated with a property, which may be referred to as a property node. Entities of the type may be connected to nodes defining particular values of those properties. For example, the entity type node “Person” may be connected to property node “Date of Birth” and a node “Height.” Further, the node “Date of Birth” may be connected to the literal type node “Date/Time,” indicating that literals associated with “Date of Birth” include date/time information. The entity node “George Washington,” which is connected to entity type node “Person” by an “Is A” edge, may also be connected to a literal “Feb. 22, 1732” by the edge “Has Date Of Birth.” In some implementations, the entity node “George Washington” is connected to a “Date Of Birth” property node. It will be understood that in some implementations, both schema and data are modeled and stored in a knowledge graph using the same technique. In this way, both schema and data can be accessed by the same search techniques. In some implementations, schemas are stored in a separate table, graph, list, other data structure, or any combination thereof. It will also be understood that properties may be modeled by nodes, edges, literals, any other suitable data, or any combination thereof.

For example, the entity node “George Washington” may be connected by an “Is A” edge to the entity type node representing “Person,” thus indicating an entity type of the entity, and may also be connected to a literal “Feb. 22, 1732” by the edge “Has Date Of Birth,” thus defining a property of the entity. In this way, the knowledge graph defines both entity types and properties associated with a particular entity by connecting to other nodes. In some implementations, “Feb. 22, 1732” may be a node, such that it is connected to other events occurring on that date. In some implementations, the date may be further connected to a year node, a month node, and a day of node. It will be understood that this information may be stored in any suitable combination of literals, nodes, terminal nodes, interconnected entities, any other suitable arrangement, or any combination thereof.

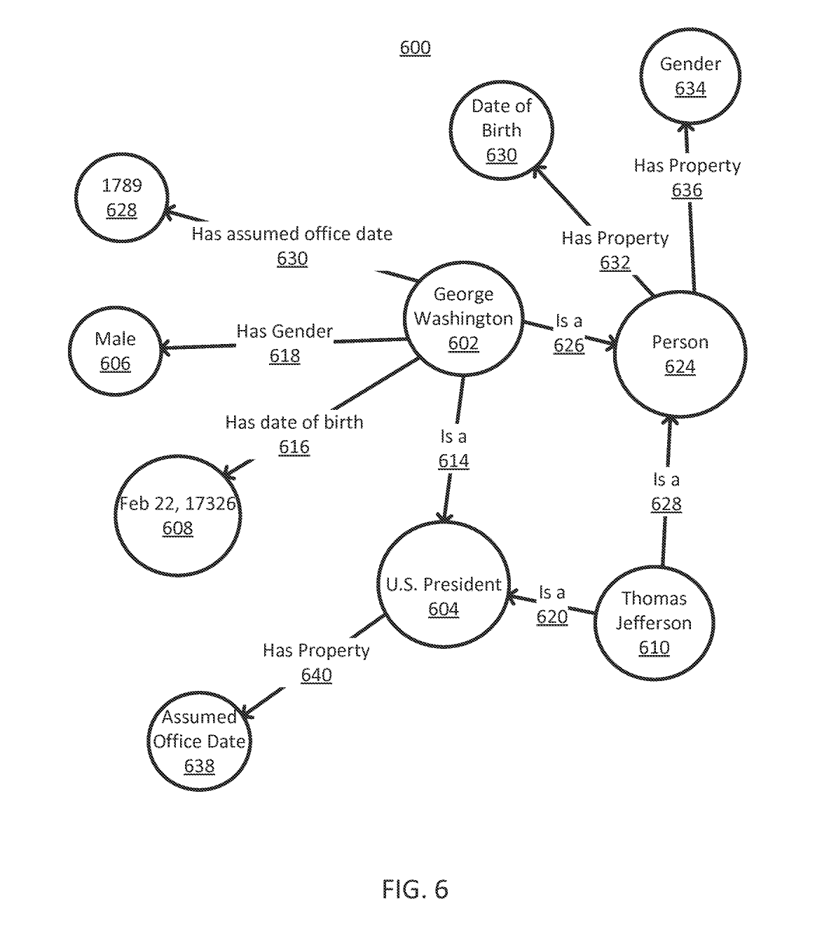

FIG. 6 shows illustrative knowledge graph portion 600 in accordance with some implementations of the present disclosure. Knowledge graph portion 600 includes information related to the entity “George Washington,” represented by “George Washington” node 602. “George Washington” node 602 is connected to “U.S. President” entity type node 604 by Is A″ edge 614 with the semantic content “Is A,” such that the 3-tuple defined by nodes 602 and 604 and the edge 614 contains the information “George Washington is a U.S. President.” Similarly, the information “Thomas Jefferson Is A U.S. President” is represented by the tuple of “Thomas Jefferson” node 610, Is A″ edge 620, and “U.S. President” node 604. Knowledge graph portion 600 includes entity type nodes “Person” 624, and “U.S. President” node 604. The person type is defined in part by the connections from “Person” node 624. For example, the type “Person” is defined as having the property “Date Of Birth” by node 630 and edge 632, and is defined as having the property “Gender” by node 634 and edge 636. These relationships define in part a schema associated with the entity type “Person.”

“George Washington” node 602 is shown in knowledge graph portion 600 to be of the entity types “Person” and “U.S. President,” and thus is connected to nodes containing values associated with those types. For example, “George Washington” node 602 is connected by “Has Gender” edge 618 to “Male” node 606, thus indicating that “George Washington has gender “Male.” Further, “Male” node 606 may be connected to the “Gender” node 634 indicating that “Male Is A Type Of Gender.” Similarly, “George Washington” node 602 is be connected by “Has Date of Birth” edge 616 to “Feb. 22, 1732” node 608, thus indicating that “George Washington Has Date Of Birth Feb. 22, 1732.” “George Washington” node 602 may also be connected to “1789” node 628 by “Has Assumed Office Date” edge 630.

Knowledge graph portion 600 also includes “Thomas Jefferson” node 610, connected by “Is A” edge 620 to entity type “U.S. President” node 604 and by “Is A” edge 628 to “Person” entity type node 624. Thus, knowledge graph portion 600 indicates that “Thomas Jefferson” has the entity types “U.S. President” and “Person.” In some implementations, “Thomas Jefferson” node 610 is connected to nodes not shown in FIG. 6 referencing his date of birth, gender, and assumed office date.

It will be understood that knowledge graph portion 600 is merely an example and that it may include nodes and edges not shown. For example, “U.S. President” node 604 may be connected to all of the U.S. Presidents. “U.S. President” node 604 may also be connected to properties related to the entity type such as a duration of term, for example “4 Years,” a term limit, for example “2 Terms,” a location of office, for example “Washington D.C.,” any other suitable data, or any combination thereof. For example, “U.S. President” node 604 is connected to “Assumed Office Date” node 638 by “Has Property” edge 640, defining in part a schema for the type “U.S. President.” Similarly, “Thomas Jefferson” node 610 may be connected to any suitable number of nodes containing further information related to his illustrated entity type nodes “U.S. President,” and “Person,” and to other entity type nodes not shown such as “Inventor,” “Vice President,” and “Author.” In a further example, “Person” node 624 may be connected to all entities in the knowledge graph with the type “Person.” In a further example, “1789” node 628 may be connected to all events in the knowledge graph with the property of year “1789.” “1789” node 628 is unique to the year 1789, and disambiguated from, for example, a book entitled “1789,” not shown in FIG. 6, by its unique identification reference. In some implementations, “1789” node 628 is connected to the entity type node “Year.”

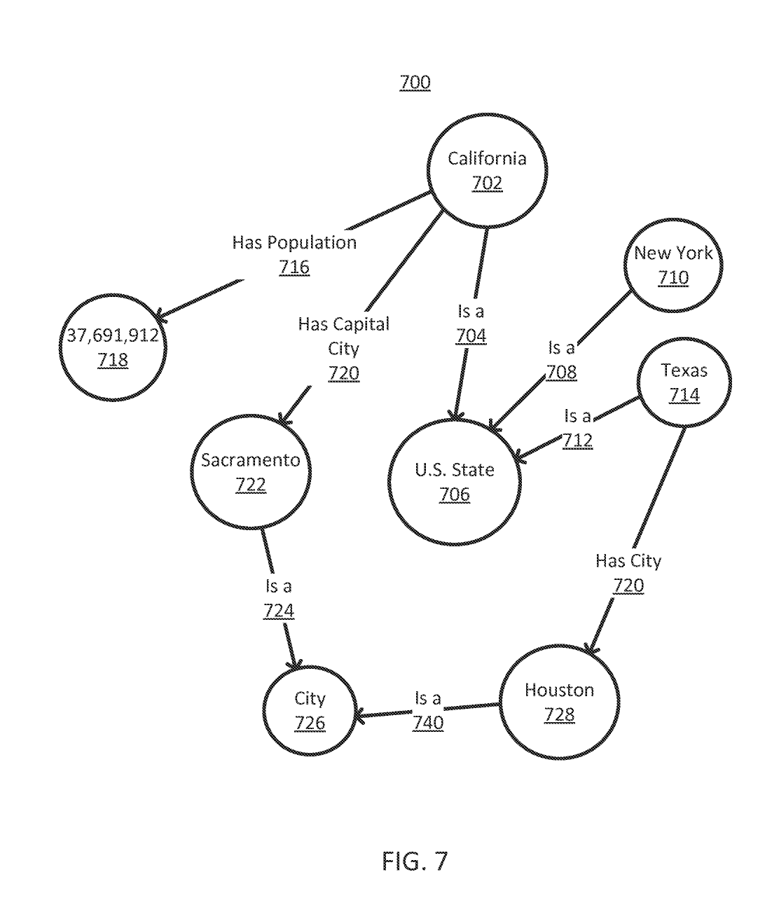

FIG. 7 shows illustrative knowledge graph portion 700 in accordance with some implementations of the present disclosure. Knowledge graph portion 700 includes “California” node 702, which may also be associated with differentiation aliases such as, for example, “CA,” “Calif.,” “Golden State,” any other suitable differentiation aliases, or any combination thereof. In some implementations, these differentiations are stored in “California” node 702. California is connected by “Is A” edge 704 to the “U.S. State” entity type node 706. “New York” node 710 and “Texas” node 714 are also connected to “U.S. State” node 706 by “Is A” edges 708 and 712, respectively. “California” node 702 is connected by “Has Capital City” edge 720 to “Sacramento” node 722, indicating the information that “California Has Capital City Sacramento.” Sacramento node 722 is further connected by “Is A” edge 724 to the “City” entity type node 726. Similarly, “Texas” node 714 is connected by “Has City” edge 720 to “Houston” node 728, which is further connected to the “City” entity type node 726 by “Is A” edge 740. “California” node 702 is connected by “Has Population” edge 716 to node 718 containing the literal value “37,691,612.” In an example, the particular value “37,691,612” may be periodically automatically updated by the knowledge graph based on an external website or other source of data. Knowledge graph portion 700 may include other nodes not shown. For example, “U.S. State” entity type node 706 may be connected to nodes defining properties of that entity type such as “Population” and “Capital City.” These entity type-property relationships may be used to define other relationships in knowledge graph portion 700 such as “Has Copulation” edge 716 connecting entity node “California” 716 with terminal node 718 containing the literal defining the population of California.

It will be understood that while knowledge graph portion 600 of FIG. 6 and knowledge graph portion 700 of FIG. 7 below show portions of a knowledge graph, all pieces of information may be contained within a single graph and that these selections illustrated herein are merely an example. In some implementations, separate knowledge graphs are maintained for different respective domains, for different respective entity types, or according to any other suitable delimiting characteristic. In some implementations, separate knowledge graphs are maintained according to size constraints. In some implementations, a single knowledge graph is maintained for all entities and entity types.

A knowledge graph may be implemented using any suitable software constructs. In an example, a knowledge graph is implemented using object oriented constructs in which each node is an object with associated functions and variables. Edges, in this context, may be objects having associated functions and variables. In some implementations, data contained in a knowledge graph, pointed to by nodes of a knowledge graph, or both, is stored in any suitable one or more data repositories across one or more servers located in one or more geographic locations coupled by any suitable network architecture.

FIG. 8 shows flow diagram 800 including illustrative steps for related entity search in accordance with some implementations of the present disclosure. In some implementations, flow diagram 800 may include steps to determine related search queries and related collections, and related entity references, as illustrated in user interfaces 200 of FIG. 2, 300 of FIG. 3, and 400 of FIG. 4. In some implementations, flow diagram 800 relies on a data structure such as the knowledge graph described above, data structure block 104 of FIG. 1, any other suitable data structure, or any combination thereof.

In step 802, the search system obtains a plurality of results identifying entities. In some implementations, the results identifying entities are search results. In some implementations, the search system retrieves results identifying entities based on a received search query. For example, the search system receives a search query in search box such as search box 202 of FIG. 2, and obtains results identifying entities based on the search query. In some implementations, the received search query corresponds to query block 102 of FIG. 1. In some implementations, results identifying entities are obtained based on a search of the internet, a database, an index, a list, webpages such as those associated with webpages block 110 of FIG. 1, a data structure such as that associated with data structure block 104 of FIG. 1, a data structure such as the knowledge graph described above, any other suitable data, or any combination thereof. In some implementations, results identifying entities are obtained from a collection of webpages such as webpages block 110 of FIG. 1. Searches are carried out by the search system using any suitable search technique. In some implementations, results identifying entities are obtained using a technique based on the structure of data structure 104 of FIG. 1. In an example, where data structure 104 of FIG. 1 includes a database, results identifying entities are obtained using database searching techniques. In another example, where data structure 104 of FIG. 1 includes a knowledge graph, results identifying entities are obtained using a structured search query built based on the received search query, where the structure of the query is substantially similar to the structure of the knowledge graph. In an example, a structured search query with two nodes and an edge connecting them is built based on a received search query, and the search system may traverse the knowledge graph, identifying nodes and edges, i.e., entities references, in the graph with content similar to the structured search query. In another example, searching includes a matching search keywords to an index. In another example, searching includes natural language processing to produce a structured query used to search a data structure such as a knowledge graph.

In step 804, the search system identifies related entity references in the knowledge graph. In some implementations, the search system identifies entity references associated with the results identifying entities in step 802, and identifies related entities based on connections in the knowledge graph or any suitable data structure. In some implementations, where the search results are based on data in a data structure such as a knowledge graph, the search system identifies related entity references based on those results identifying entities. In some implementations, related entity references are identified in a knowledge graph and share an entity type with the search results. In some implementations, related entity references are a subset of the results identifying entities obtained in step 802. For example, where the results identifying entities include movies with a particular actor, related entity references may include movies of a particular genre with that actor. In some implementations, related entity references may share the same or a similar relationship in a knowledge graph. For example, where an entity is connected to a type or property by an edge in the knowledge graph, related entity references may be connected to that same type or property, or to more than one related link. In an example, where the entity corresponds to country “Canada” and it is connected in the knowledge graph by edges to the entity type “Country” and the entity “North America,” other entities connected to both “Country and “North America,” e.g., The United States and Mexico, may be identified as related entity references. In some implementations, where the results identifying entities are based on a search of the internet or some other database, the search system first identifies entities in the knowledge graph associated with the results identifying entities, and then identifies related entity references related to the identified entities.

In step 806, the search system determines relationships between the results identifying entities and the related entity references. In some implementations, relationships between the entities and the related entity references may be modeled in a data structure such as a knowledge graph. In some implementations, determining relationships includes identifying those relationships and determining properties associated with the relationships. In some implementations, determining relationships includes mapping connections in graph-based data structure. In some implementations, mapping a connection includes identifying an edge, an edge and a node, multiple nodes, or any other suitable collection of nodes and edges that describe the relationship between an entity and a related entity. In an example, results identifying entities for “1980's movies” may include the movie “Jaws.” The search system may identify “Steven Spielberg” as a related entity, map the connection between the movie “Jaws” and the director “Steven Spielberg” in the graph as having the information “is a director of,” and may identifies other entities where Steven Spielberg is a director. In some implementations, mapped relationships may be one-to-one, one-to-many, many-to-one, or many-to many. In some implementations of a data structure, relationships between entities may be annotated, i.e., labeled, such that they include information about the relationship. For example, the relationship between the movie “Psycho” and the genre “Thriller” may include in the information “is of the genre.” In another example, the relationships between two entities may be identified based on the number of links between the entities, the statistical distance between the entities, other entities related to both the entity and the related entity, any other suitable characteristics, or any combination thereof.

In step 808, the search system provides access to a related plurality of results identifying entities. In some implementations, the related collection of results identifying entities is determined based on the relationships determined in step 806. For example, where the search system determines a relationship between several movies and genre “Thriller,” the search system may provide access to a collection of “Thriller Movies.”

In some implementations, providing access to a related collection of entity references includes displaying a link to a collection, as illustrated in user interface 200 of FIG. 2, displaying a menu with links to related collections as illustrated in user interface 300 of FIG. 3, displaying some or all of the collection as illustrated in user interface 400 of FIG. 4, displaying a link connecting to a page of related collections, displaying any other suitable content, or any combination thereof.

In some implementations, the related collection of entity references may be determined based on data stored in a knowledge graph, a search of the internet, a search of any suitable database, a search of any suitable index, a search of any other suitable data, or any combination thereof. In some implementations, the search system may provide access to related collections through thumbnail links as illustrated in user interface 200 of FIG. 2, may provide access to a collection of links to related search queries and/or collections in a menu as illustrated in user interface 300 of FIG. 3, may provide access to particular entities of a related collection as illustrated in user interface 300 of FIG. 3, may provide access by any other suitable technique, or any combination thereof.

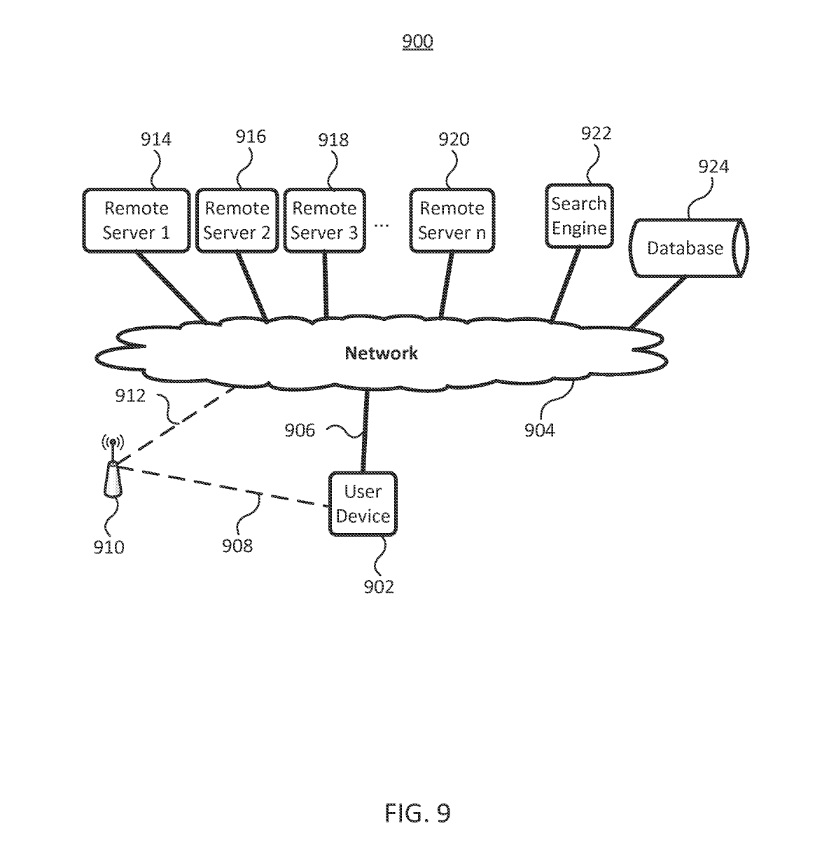

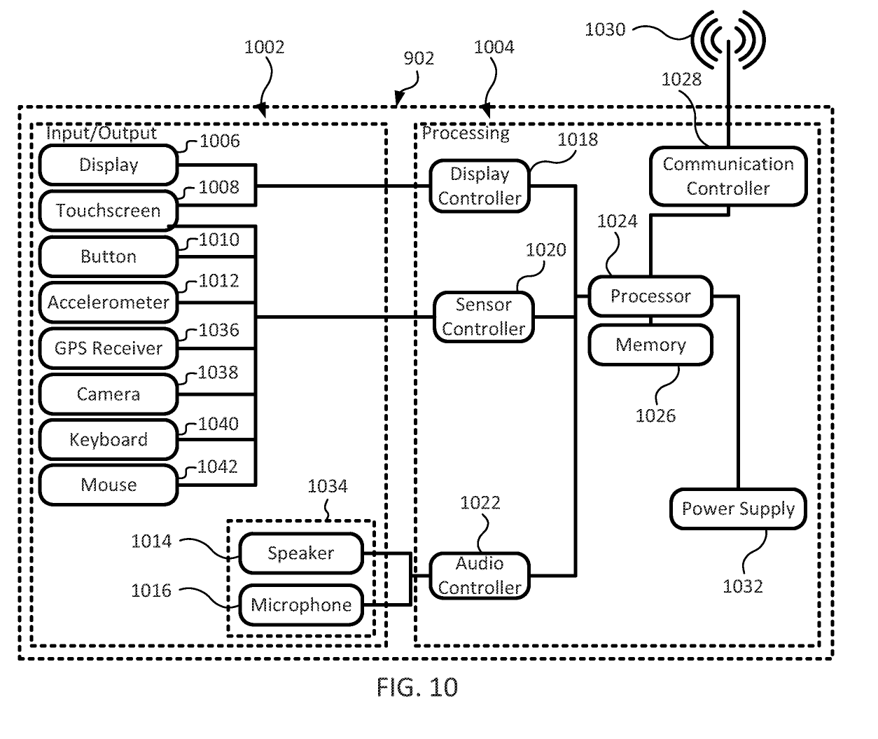

The following description and accompanying FIGS. 9-10 describe illustrative computer systems that may be used in some implementations of the present disclosure. It will be understood that the knowledge graph and associated techniques may be implemented on any suitable computer or combination of computers.

FIG. 9 shows illustrative search system 900 that may be used to implement some or all features of the search system in accordance with some implementations of the present disclosure. System 900 may include one or more user device 902. In some implementations, user device 902 may include a smartphone, tablet computer, desktop computer, laptop computer, personal digital assistant or PDA, portable audio player, portable video player, mobile gaming device, other suitable user device capable of providing content, or any combination thereof.

User device 902 may be coupled to network 904 directly through connection 906, through wireless repeater 910, by any other suitable way of coupling to network 904, or by any combination thereof. Network 904 may include the Internet, a dispersed network of computers and servers, a local network, a public intranet, a private intranet, other coupled computing systems, or any combination thereof.

User device 902 may be coupled to network 904 by wired connection 906. Connection 906 may include Ethernet hardware, coaxial cable hardware, DSL hardware, T-1 hardware, fiber optic hardware, analog phone line hardware, any other suitable wired hardware capable of communicating, or any combination thereof. Connection 906 may include transmission techniques including TCP/IP transmission techniques, IEEE 1002 transmission techniques, Ethernet transmission techniques, DSL transmission techniques, fiber optic transmission techniques, ITU-T transmission techniques, any other suitable transmission techniques, or any combination thereof.

User device 902 may be wirelessly coupled to network 904 by wireless connection 908. In some implementations, wireless repeater 910 receives transmitted information from user device 902 by wireless connection 908 and communicates it with network 904 by connection 912. Wireless repeater 910 receives information from network 904 by connection 912 and communicates it with user device 902 by wireless connection 908. In some implementations, wireless connection 908 may include cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Connection 912 may include Ethernet hardware, coaxial cable hardware, DSL hardware, T-1 hardware, fiber optic hardware, analog phone line hardware, wireless hardware, any other suitable hardware capable of communicating, or any combination thereof. Connection 912 may include wired transmission techniques including TCP/IP transmission techniques, IEEE 1002 transmission techniques, Ethernet transmission techniques, DSL transmission techniques, fiber optic transmission techniques, ITU-T transmission techniques, any other suitable transmission techniques, or any combination thereof. Connection 912 may include may include wireless transmission techniques including cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Wireless repeater 910 may include any number of cellular phone transceivers, network routers, network switches, communication satellites, other devices for communicating information from user device 902 to network 904, or any combination thereof. It will be understood that the arrangement of connection 906, wireless connection 908 and connection 912 is merely illustrative and that system 900 may include any suitable number of any suitable devices coupling user device 902 to network 904. It will also be understood that any user device 902, may be communicatively coupled with any user device, remote server, local server, any other suitable processing equipment, or any combination thereof, and may be coupled using any suitable technique as described above.

In some implementations, any suitable number of remote servers 914, 916, 918, 920, may be coupled to network 904. Remote servers may be general purpose, specific, or any combination thereof. One or more search engine servers 922 may be coupled to the network 904. In some implementations, search engine server 922 may include the knowledge graph, may include processing equipment configured to access the knowledge graph, may include processing equipment configured to receive search queries related to the knowledge graph, may include any other suitable information or equipment, or any combination thereof. One or more database servers 924 may be coupled to network 904. In some implementations, database server 924 may store the knowledge graph. In some implementations, where there is more than one knowledge graph, the more than one may be included in database server 924, may be distributed across any suitable number of database servers and general purpose servers by any suitable technique, or any combination thereof. It will also be understood that the search system may use any suitable number of general purpose, specific purpose, storage, processing, search, any other suitable server, or any combination.

FIG. 10 is a block diagram of a user device of the illustrative computer system of FIG. 9 in accordance with some implementations of the present disclosure. User device 902 may include input/output equipment 1002 and processing equipment 1004. Input/output equipment 1002 may include display 1006, touchscreen 1008, button 1010, accelerometer 1012, global positions system or GPS receiver 1036, camera 1038, keyboard 1040, mouse 1042, and audio equipment 1034 including speaker 1014 and microphone 1016. In some implementations, the equipment illustrated in FIG. 10 may be representative of equipment included in a smartphone user device. It will be understood that the specific equipment included in the illustrative computer system may depend on the style of user device. For example, the Input/output equipment 1002 of a desktop computer may include a keyboard 1040 and mouse 1042 and may omit accelerometer 1012 and GPS receiver 1036. It will be understood that user device 902 may omit any suitable illustrated elements, and may include equipment not shown such as media drives, data storage, communication devices, display devices, processing equipment, any other suitable equipment, or any combination thereof.

In some implementations, display 1006 may include a liquid crystal display, light emitting diode display, organic light emitting diode display, amorphous organic light emitting diode display, plasma display, cathode ray tube display, projector display, any other suitable display capable of displaying content, or any combination thereof. Display 1006 may be controlled by display controller 1018 or by processor 1024 in processing equipment 1004, by processing equipment internal to display 1006, by other controlling equipment, or by any combination thereof. In some implementations, display 1006 may display data from a knowledge graph.

Touchscreen 1008 may include a sensor capable of sensing pressure input, capacitance input, resistance input, piezoelectric input, optical input, acoustic input, any other suitable input, or any combination thereof. Touchscreen 1008 may be capable of receiving touch-based gestures. Received gestures may include information relating to one or more locations on the surface of touchscreen 1008, pressure of the gesture, speed of the gesture, duration of the gesture, direction of paths traced on its surface by the gesture, motion of the device in relation to the gesture, other suitable information regarding a gesture, or any combination thereof. In some implementations, touchscreen 1008 may be optically transparent and located above or below display 1006. Touchscreen 1008 may be coupled to and controlled by display controller 1018, sensor controller 1020, processor 1024, any other suitable controller, or any combination thereof. In some implementations, touchscreen 1008 may include a virtual keyboard capable of receiving, for example, a search query used to identify data in a knowledge graph.

In some embodiments, a gesture received by touchscreen 1008 may cause a corresponding display element to be displayed substantially concurrently, i.e., immediately following or with a short delay, by display 1006. For example, when the gesture is a movement of a finger or stylus along the surface of touchscreen 1008, the search system may cause a visible line of any suitable thickness, color, or pattern indicating the path of the gesture to be displayed on display 1006. In some implementations, for example, a desktop computer using a mouse, the functions of the touchscreen may be fully or partially replaced using a mouse pointer displayed on the display screen.

Button 1010 may be one or more electromechanical push-button mechanism, slide mechanism, switch mechanism, rocker mechanism, toggle mechanism, other suitable mechanism, or any combination thereof. Button 1010 may be included in touchscreen 1008 as a predefined region of the touchscreen, e.g. soft keys. Button 1010 may be included in touchscreen 1008 as a region of the touchscreen defined by the search system and indicated by display 1006. Activation of button 1010 may send a signal to sensor controller 1020, processor 1024, display controller 1020, any other suitable processing equipment, or any combination thereof. Activation of button 1010 may include receiving from the user a pushing gesture, sliding gesture, touching gesture, pressing gesture, time-based gesture, e.g. based on the duration of a push, any other suitable gesture, or any combination thereof.

Accelerometer 1012 may be capable of receiving information about the motion characteristics, acceleration characteristics, orientation characteristics, inclination characteristics and other suitable characteristics, or any combination thereof, of user device 902. Accelerometer 1012 may be a mechanical device, microelectromechanical or MEMS device, nanoelectromechanical or NEMS device, solid state device, any other suitable sensing device, or any combination thereof. In some implementations, accelerometer 1012 may be a 3-axis piezoelectric microelectromechanical integrated circuit which is configured to sense acceleration, orientation, or other suitable characteristics by sensing a change in the capacitance of an internal structure. Accelerometer 1012 may be coupled to touchscreen 1008 such that information received by accelerometer 1012 with respect to a gesture is used at least in part by processing equipment 1004 to interpret the gesture.

Global positioning system or GPS receiver 1036 may be capable of receiving signals from global positioning satellites. In some implementations, GPS receiver 1036 may receive information from one or more satellites orbiting the earth, the information including time, orbit, and other information related to the satellite. This information may be used to calculate the location of user device 902 on the surface of the earth. GPS receiver 1036 may include a barometer, not shown, to improve the accuracy of the location. GPS receiver 1036 may receive information from other wired and wireless communication sources regarding the location of user device 902. For example, the identity and location of nearby cellular phone towers may be used in place of, or in addition to, GPS data to determine the location of user device 902.

Camera 1038 may include one or more sensors to detect light. In some implementations, camera 1038 may receive video images, still images, or both. Camera 1038 may include a charged coupled device or CCD sensor, a complementary metal oxide semiconductor or CMOS sensor, a photocell sensor, an IR sensor, any other suitable sensor, or any combination thereof. In some implementations, camera 1038 may include a device capable of generating light to illuminate a subject, for example, an LED light. Camera 1038 may communicate information captured by the one or more sensor to sensor controller 1020, to processor 1024, to any other suitable equipment, or any combination thereof. Camera 1038 may include lenses, filters, and other suitable optical equipment. It will be understood that user device 902 may include any suitable number of camera 1038.

Audio equipment 1034 may include sensors and processing equipment for receiving and transmitting information using acoustic or pressure waves. Speaker 1014 may include equipment to produce acoustic waves in response to a signal. In some implementations, speaker 1014 may include an electroacoustic transducer wherein an electromagnet is coupled to a diaphragm to produce acoustic waves in response to an electrical signal. Microphone 1016 may include electroacoustic equipment to convert acoustic signals into electrical signals. In some implementations, a condenser-style microphone may use a diaphragm as a portion of a capacitor such that acoustic waves induce a capacitance change in the device, which may be used as an input signal by user device 902.

Speaker 1014 and microphone 1016 may be contained within user device 902, may be remote devices coupled to user device 902 by any suitable wired or wireless connection, or any combination thereof.

Speaker 1014 and microphone 1016 of audio equipment 1034 may be coupled to audio controller 1022 in processing equipment 1004. This controller may send and receive signals from audio equipment 1034 and perform pre-processing and filtering steps before transmitting signals related to the input signals to processor 1024. Speaker 1014 and microphone 1016 may be coupled directly to processor 1024. Connections from audio equipment 1034 to processing equipment 1004 may be wired, wireless, other suitable arrangements for communicating information, or any combination thereof.

Processing equipment 1004 of user device 902 may include display controller 1018, sensor controller 1020, audio controller 1022, processor 1024, memory 1026, communication controller 1028, and power supply 1032.

Processor 1024 may include circuitry to interpret signals input to user device 902 from, for example, touchscreen 1008 and microphone 1016. Processor 1024 may include circuitry to control the output to display 1006 and speaker 1014. Processor 1024 may include circuitry to carry out instructions of a computer program. In some implementations, processor 1024 may be an integrated electronic circuit based, capable of carrying out the instructions of a computer program and include a plurality of inputs and outputs.

Processor 1024 may be coupled to memory 1026. Memory 1026 may include random access memory or RAM, flash memory, programmable read only memory or PROM, erasable programmable read only memory or EPROM, magnetic hard disk drives, magnetic tape cassettes, magnetic floppy disks optical CD-ROM discs, CD-R discs, CD-RW discs, DVD discs, DVD+R discs, DVD-R discs, any other suitable storage medium, or any combination thereof.

The functions of display controller 1018, sensor controller 1020, and audio controller 1022, as have been described above, may be fully or partially implemented as discrete components in user device 902, fully or partially integrated into processor 1024, combined in part or in full into combined control units, or any combination thereof.

Communication controller 1028 may be coupled to processor 1024 of user device 902. In some implementations, communication controller 1028 may communicate radio frequency signals using antenna 1030. In some implementations, communication controller 1028 may communicate signals using a wired connection, not shown. Wired and wireless communications communicated by communication controller 1028 may use Ethernet, amplitude modulation, frequency modulation, bitstream, code division multiple access or CDMA, global system for mobile communications or GSM, general packet radio service or GPRS, satellite, infrared, Bluetooth, Wi-Fi, WiMax, any other suitable communication configuration, or any combination thereof. The functions of communication controller 1028 may be fully or partially implemented as a discrete component in user device 902, may be fully or partially included in processor 1024, or any combination thereof. In some implementations, communication controller 1028 may communicate with a network such as network 904 of FIG. 9 and may receive information from a knowledge graph stored, for example, in database 924 of FIG. 9.

Power supply 1032 may be coupled to processor 1024 and to other components of user device 902. Power supply 1032 may include a lithium-polymer battery, lithium-ion battery, NiMH battery, alkaline battery, lead-acid battery, fuel cell, solar panel, thermoelectric generator, any other suitable power source, or any combination thereof. Power supply 1032 may include a hard wired connection to an electrical power source, and may include electrical equipment to convert the voltage, frequency, and phase of the electrical power source input to suitable power for user device 902. In some implementations of power supply 1032, a wall outlet may provide 120V, 60 Hz alternating current or AC. A circuit of transformers, resistors, inductors, capacitors, transistors, and other suitable electronic components included in power supply 1032 may convert the 120V AC from a wall outlet power to 5 volts at 0 Hz, i.e., direct current. In some implementations of power supply 1032, a lithium-ion battery including a lithium metal oxide-based cathode and graphite-based anode may supply 3.7V to the components of user device 902. Power supply 1032 may be fully or partially integrated into user device 902, or may function as a stand-alone device. Power supply 1032 may power user device 902 directly, may power user device 902 by charging a battery, may provide power by any other suitable way, or any combination thereof.

The foregoing is merely illustrative of the principles of this disclosure and various modifications may be made by those skilled in the art without departing from the scope of this disclosure. The above described implementations are presented for purposes of illustration and not of limitation. The present disclosure also may take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

1. A method comprising:
obtaining, using one or more computers, a plurality of search results identifying entities from a knowledge graph, wherein at least one search result of the plurality of search results is associated with an entity in the knowledge graph;
identifying, using one or more computers, one or more related entities from the knowledge graph, wherein each related entity is related to at least one of the entities associated with the plurality of search results;
determining, using one or more computers, one or more graph edges of the knowledge graph that link nodes corresponding to the one or more entities with nodes corresponding to the one or more related entities;
generating a triple for each of the one or more determined graph edges, the triple comprising a grouping of one of the one or more graph edges, a first node corresponding to one of the one or more entities, and a second node corresponding to one of the one or more related entities;
analyzing each generated triple to identify additional entities in the knowledge graph and a related plurality of results; and
providing, using one or more computers, access to the related plurality of results.

2. The method of claim 1, wherein providing access to the related plurality of results comprises providing access to a collection of results identifying entities that are all of the same type.

3. The method of claim 1, wherein providing access to the related plurality of results comprises providing links based on relevance.

4. The method of claim herein providing access to the related plurality of results comprises identifying results identifying entities having nodes that form a triple corresponding to a relationship matching at least one of a plurality of relationships.

5. The method of claim 1, wherein providing access to the related plurality of results comprises providing access to a collection of results that are substantially contained in the plurality of search results.

6. The method of claim 1, wherein determining the one or more graph edges comprises identifying one or more entity types associated with the entities and the related entities.

7. The method of claim 1, wherein determining the one or more graph edges comprises identifying values associated with the entities and the related entities.

8. The method of claim 1, wherein providing access to the related plurality of results comprises displaying links to collections in a related collection area of a display screen.

9. The method of claim 1, wherein providing access to the related plurality of results comprises displaying links in a horizontally scrollable display.

10. The method of claim 1, wherein providing access to the related plurality of results comprises displaying links in a pull-down menu.

11. A system comprising:
a database comprising a knowledge graph; and
one or more computers configured to perform operations including:
obtaining a plurality of search results identifying entities from the knowledge graph, wherein at least one search result of the plurality of search results identifying entities is associated with an entity in the knowledge graph,
identifying one or more related entities from the knowledge graph, wherein each related entity is related to at least one of the entities associated with the plurality of search results identifying entities,
determining one or more graph edges of the knowledge graph that link nodes corresponding to the one or more entities with nodes corresponding to the one or more related entities,
generating a triple for each of the one or more determined graph edges, the triple comprising a grouping of one of the one or more graph edges, a first node corresponding to one of the one or more entities, and a second node corresponding to one of the one or more related entities,
analyzing each generated triple to identify additional entities in the knowledge graph and a related plurality of results, and
providing access to the related plurality of results.

12. The system of claim 11, wherein the one or more computers are further configured to provide access to a collection of results identifying entities that are all of the same type.

13. The system of claim 11, wherein the one or more computers are further configured to provide links based on relevance.

14. The system of claim 11, wherein the one or more computers are further configured to identify results identifying entities having nodes that form a triple corresponding to a relationship matching at least one of a plurality of relationships.

15. The system of claim 11, wherein the one or more computers are further configured to provide access to a collection of results that are substantially contained in the plurality of search results.

16. The system of claim 11, wherein the one or more computers are further configured to identify one or more entity types associated with the entities and the related entities.

17. The system of claim 11, wherein the one or more computers are further configured to identify values associated with the entities and the related entities.

18. The system of claim 11, wherein the one or more computers are further configured to display links to collections in a related collection area of a display screen.

19. The system of claim 11, wherein the one or more computers are further configured to display links in a horizontally scrollable display.

20. The system of claim 11, wherein the one or more computers are further configured to display links in a pull-down menu.

21. A non-transitory computer-readable medium having instructions recorded thereon that, when executed by at least one processor, cause the processor to perform a method comprising:
obtaining, using one or more computers, a plurality of search results identifying entities from a knowledge graph, wherein at least one search result of the plurality of search results identifying entities is associated with an entity in the knowledge graph;
identifying, using one or more computers, one or more related entities from the knowledge graph, wherein each related entity is related to at least one of the entities associated with the plurality of search results identifying entities;
determining, using one or more computers, one or more graph edges of the knowledge graph linking nodes corresponding to the one or more entities with nodes corresponding to the one or more related entities;
generating a triple for each of the one or more determined graph edges, the triple comprising a grouping of one of the one or more graph edges, a first node corresponding to one of the one or more entities, and a second node corresponding to one of the one or more related entities;
analyzing each generated triple to identify additional entities in the knowledge graph and a related plurality of results; and
providing, using one or more computers, access to the related plurality of results identifying entities.

22. The non-transitory computer readable medium of claim 21, wherein providing access to the related plurality of results comprises providing access to a collection of results identifying entities that are all of the same type.

23. The non-transitory computer readable medium of claim 21, wherein providing access to the related plurality of results comprises providing links based on relevance.

24. The non-transitory computer readable medium of claim 21, wherein providing access to the related plurality of results comprises identifying results identifying entities having nodes that form a triple corresponding to a relationship matching at least one of a plurality of relationships.

25. The non-transitory computer readable medium of claim 21, wherein providing access to the related plurality of results comprises providing access to a collection of results that are substantially contained in the plurality of search results.

26. The non-transitory computer readable medium of claim 21, wherein determining the one or more graph edges comprises identifying one or more entity types associated with the entities and the related entities.

27. The non-transitory computer readable medium of claim 21, wherein determining the one or more graph edges comprises identifying values associated with the entities and the related entities.

28. The non-transitory computer readable medium of claim 21, wherein providing access to the related plurality of results comprises displaying links to collections in a related collection area of a display screen.

29. The non-transitory computer readable medium of claim 21, wherein providing access to the related plurality of results comprises displaying links in a horizontally scrollable display.

30. The non-transitory computer readable medium of claim 21, wherein providing access to the related plurality of results comprises displaying links in a pull-down menu.

31. The method of claim 1, further comprising:
identifying, based on at least on one generated triple, one or more alternative text queries;
determining additional results based on the one or more alternative text queries; and
providing access to the additional results.

32. The system of claim 11, the one or more computers are further configured to perform operations including:
identifying, based on at least in part on one generated triple, one or ore alternative text queries;
determining additional results based on the one or more alternative text queries; and
providing access to the additional results.

33. The non-transitory computer readable medium of claim 21, wherein the method further comprises:
identifying, based on at least in part on one generated triple, one or more alternative text queries;
determining additional results based on the one or more alternative text queries; and
providing access to the additional results.
